(19) United States
(12) Patent Application Publication
(10) Pub. No.: US 2009/0046392 A1
(43) Pub. Date: Feb. 19, 2009

(54) Voice coil motor and hard disk drive with the same

(75) Inventors: JianFeng Xu, Dong Guan (CN); YanChu Xu, San Jose, CA (US); LingJun Kong, Dong Guan (CN); LiXin Wu, Dong Guan (CN); Thao Nguyen, San Jose, CA (US)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 11/898,558

(22) Filed: Sep. 13, 2007

(30) Foreign Application Priority Data
Aug. 13, 2007 (CN) 200710147014.6

(51) Int. Cl. G11B 5/55

(52) U.S. Cl. 360/264.7

(57) ABSTRACT

A voice coil motor for a hard disk drive includes an inner core having an inner surface, an outer plate having an inner surface, a permanent magnet, and a coil of wire. The outer plate is positioned in spaced relation to the inner core such that a gap is defined between the inner surfaces of the inner core and the outer plate. The permanent magnet is located in the gap and attached to the inner surface of the outer plate. The coil of wire wraps around the inner core to form a solenoid coil. With such structure, the stiffness of the coil is increased. The invention also discloses a disk drive with such VCM in which the coil is directly bonded to the E-block of the hard disk drive. Therefore heat conduction of the hard disk drive is improved.

### FIELD OF THE INVENTION

The present invention relates to information recording hard disk drive devices, and more particularly to a voice coil motor (VCM) for a hard disk drive with special structure for increasing stiffness of the coil and improving heat conduction of the hard disk drive.

### BACKGROUND OF THE INVENTION

Hard disk drive is an information storage device that use magnetic media to store data and a movable read/write head positioned over the magnetic media to selectively read data from and write data to the magnetic media.

As shown in FIG. 1, a conventional hard disk drive unit includes a magnetic disk 10 mounted on a spindle motor 20 for spinning the disk 10 at a constant high speed. A head stack assembly (HSA) 30 which carries a head 34 is actuated to move relative to the disk 10 so as to read data from or write data to the disk 10.

Typically, a VCM 36 is employed to position the head 34 with reference to data tracks across the disk surface. The HSA 30 generally comprises a HSA E-block 32 with a tip end and a tail end. A head gimbal assembly (HGA) 33 with the head 34 thereon is mounted to the tip end of the E-block 32, and a fantail 35 is mounted to the tail end of the E-block 32. The HSA 30 pivots about a pivot shaft 31 mounted to the disk drive base plate at a position closely adjacent to the outer extreme of the disk 10 so that the head 34 moves in a plane parallel with the surface of the disk 10.

The VCM 36 includes a coil 37 mounted radially outward from the pivot shaft 31 and partially embedded (e.g. by epoxy potting or overmolding) in the fantail 35, the coil 37 being immersed in the magnetic field of a magnetic circuit of the VCM 36. The magnetic circuit comprises one or more permanent magnet pairs 38 and magnetically permeable plates 39. When a predetermined driving current flows through the coil 37, rotational forces or torques about the pivot shaft are generated on the coil 37 by the interaction between the current and the magnetic field in accordance with the well-known Lorentz relationship, such that the head 34 can be moved to the expected position.

There are typically three principal torques experienced by the VCM 36 and the HSA 30 as a result of the application of current to the coil 37. The first torque, often called the main torque, causes the coil 37 and the HSA 30 to rotate about a Z-axis of the pivot shaft 31, as shown by arrow 42. The second torque, referred to as torsion torque, causes the coil 37 and the HSA 30 to rotate or twist about an X-axis of the pivot shaft 31, as shown by arrow 44. The third torque, referred to as pitch torque, causes the coil 37 and the HSA 30 to rotate or bend about a Y-axis of the pivot shaft 31, as shown by arrow 46. As is known, the main torque is the primary means by which the voice coil 37, and thus the head 34, is moved radially across the disk 10. Stated another way, the main torque is a desired force which causes the HSA 30 and the head 34 to move in a plane parallel with the disk 10. In contrast, both the torsion and pitch torques cause motions in the HSA 30, the head 34, and the coil 37 which are not parallel to the plane of the disk 10. As such, the torsion and pitch torques adversely affect the head's ability to maintain optimal flying height and to stay parallel to the disk over the data tracks, thereby interfering with the read/write operation of the head in the disk drive.

FIG. 2 shows a typical bode curve of a HSA. The curve can be viewed as the output/input ratio in frequency domain. The input is the force applied on the coil, while the output is the lateral displacement between the head and the disk. The base line of the bode curve is a straight line with a slope as −2, as shown by the dashed line. It can be seen that the coil torsion mode caused a peak happens when the frequency is 4 kHz, which will adversely affect the head's performance dramatically. Therefore, the coil torsion caused by the torsion torque is very critical in VCM design, while the coil bend caused by the pitch torque is less critical in VCM design.

Turning back to FIG. 1, the coil 37 of the VCM 36 embedded in the fantail 35 is arranged perpendicular to the Z-axis of the pivot shaft or in other word parallel to the disk 10, comprising two opposing radial arms and two concentric arc arms. Such configuration of the coil 37 causes the force arm of the torsion larger with the result of increasing the torsion in the VCM.

Referring to FIG. 1 again, the coil 37 is hollow, so the stiffness of the coil 37 is very weak, and accordingly the torsion torque generated on the coil 37 is more liable to cause the coil torsion.

In addition, when a current passes through the coil 37, heat is generated in the coil 37. As shown in FIG. 1, the coil 37 of the conventional VCM 36 is attached to the fantail 35. The heat generated on the coil has to be transferred to the fantail 35 first, and then reaches the E-block 32, the pivot 31, and the out surface of the hard disk drive, so the heat conduction route is very long. Moreover, the contact surface between the coil and the fantail is small. Both of these factors cause the heat conduction performance of the hard disk drive poor. However, a poor heat conduction of the hard disk drive will cause high temperature. The high temperature may lead to particles, which is fatal to hard disk drive. Moreover, temperature change will induce variant structure stiffness and variant dynamic properties, which may be out of control for the present servo system.

Hence, a need has arisen for providing an improved voice coil motor and a hard disk drive to solve the above-mentioned problem.

### SUMMARY OF THE INVENTION

Accordingly, an objective of the present invention is to provide a VCM for a hard disk drive with special structure for increasing stiffness of the coil and improving heat conduction of the hard disk drive.

Another objective of the present invention is to provide a hard disk drive which is capable of reducing coil torsion in the VCM and has improved heat conduction performance.

To achieve the above-mentioned objectives, a VCM for a hard disk drive according to an aspect of the present invention comprises an inner core having an inner surface, an outer plate having an inner surface, a permanent magnet, and a coil of wire. The outer plate is positioned in spaced relation to the inner core such that a gap is defined between the inner surfaces of the inner core and the outer plate. The permanent magnet is located in the gap and attached to the inner surface of the outer plate. The coil of wire wraps around the inner core to form a solenoid coil.

Preferably, the inner core, the outer plate, and the permanent magnet are all arc-shaped and concentric.

In an embodiment of the present invention, the coil and the inner core are bonded together so that the inner core moves together with the coil to further improve the stiffness of the coil.

In another embodiment of the present invention, a clearance exists between the coil and the inner core to permit the coil to move along the inner core. The outer plate is connected with the inner core by a pair of side plates at opposite sides thereof to close the gap, and thus to prevent magnetic flux leakage.

According to another aspect of the present invention, a hard disk drive comprises a disk, a spindle motor to spin the disk, a HSA having a head and an E-block at opposite ends thereof, and a VCM. The E-block is pivotally mounted on a pivot shaft. The VCM drives the HSA rotation about the pivot shaft and in turn causes the head to move radially across the disk. The VCM comprises an inner core having an inner surface, an outer plate having an inner surface, a permanent magnet, and a coil of wire. The inner core is configured to be perpendicular to the disk. The outer plate is also configured to be perpendicular to the disk and positioned in spaced relation to the inner core such that a gap is defined between the inner surfaces of the inner core and the outer plate. The permanent magnet is located in the gap and attached to the inner surface of the outer plate. The coil wraps around the inner core in a direction perpendicular to the disk to form a solenoid coil and is bonded to the E-block.

In an embodiment of the hard disk drive according to the present invention, the coil is bonded to the E-block with heat conductive adhesive.

In another embodiment of the hard disk drive according to the present invention, the E-block defines a groove in an outer surface thereof, and the coil is partially pressed into the groove so as to be fixed to the E-block.

Since the coil is attached to the E-block directly, the stiffness of the coil 14 can be increased dramatically. The inner core inside the coil can further improve the stiffness of the coil, thereby reducing the coil torsion in the VCM.

In addition, the heat generated in the coil can be directly conducted to the E-block and then the out surface of the hard disk drive, so the heat conduction performance of the hard disk drive can also be improved. Moreover, the contact surface between the coil and the E-block increases a lot, which further improves the heat conduction performance of the hard disk drive.

### BRIEF DESCRIPTION OF THE DRAWINGS

The accompanying drawings facilitate an understanding of the various embodiments of this invention. In such drawings:

FIG. 1 is a perspective view of a conventional disk drive;

FIG. 2 is a graph illustrating a typical bode curve of a HSA;

FIG. 3 is a perspective view of a hard disk drive with a VCM according to an embodiment of the present invention;

FIG. 4 is a perspective view of the VCM shown in FIG. 3;

FIG. 5 is a perspective view showing the VCM shown in FIG. 4 attached to an E-block of a HSA;

FIG. 6 is a plan view of the VCM and the HSA shown in FIG. 5;

FIG. 7 is a cross-sectional view of the assembly of the VCM and the E-block shown in FIG. 6, taken in the plane of line I-I of FIG. 6;

FIG. 8 is a plan view illustrating the VCM shown in FIG. 4 attached to an E-block according to another embodiment of the present invention;

FIG. 9 is a perspective view of a VCM according to another embodiment of the present invention;

FIG. 10 is a cross-sectional view of the VCM shown in FIG. 9;

FIG. 11 is a perspective view illustrating the VCM shown in FIG. 9 assembled with a HSA; and

FIG. 12 is a plan view of the VCM and the HSA shown in FIG. 11.

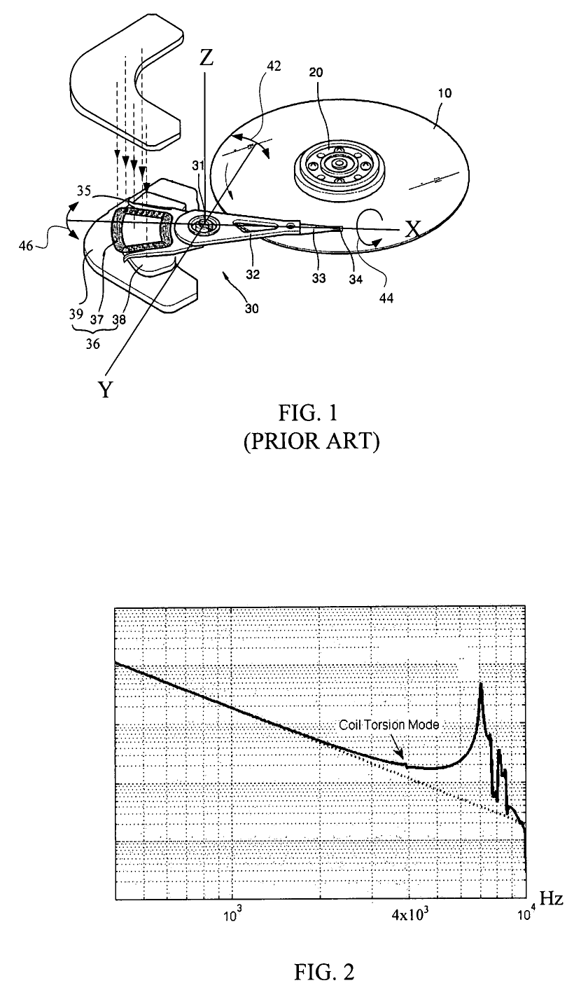

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the invention is directed to a VCM for a hard disk drive with special structure for increasing stiffness of the coil and improving heat conduction of the hard disk drive.

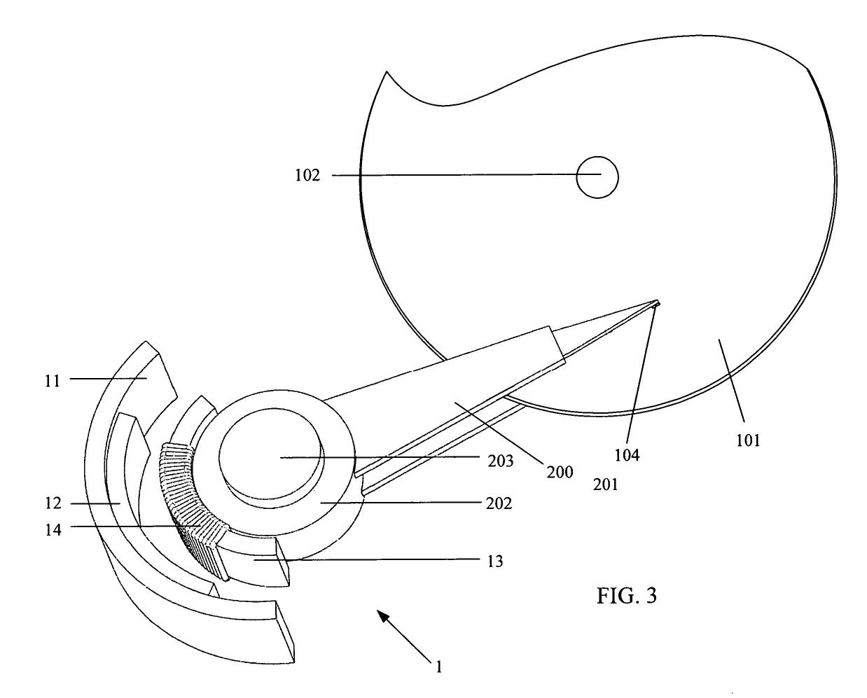

Several example embodiments of the VCM will now be described. FIG. 3 shows a hard disk drive with a VCM according to an embodiment of the present invention. The hard disk drive includes a disk 101, a spindle motor 102 to spin the disk 101, and a HSA having a head 201 and an E-block 202 at opposite ends thereof. The E-block 202 is pivotally mounted on a pivot shaft 203. The VCM 1 is bonded to the E-block 202 so as to drive the HSA rotation about the pivot shaft 203 and in turn cause the head 201 to move radially across the disk 101.

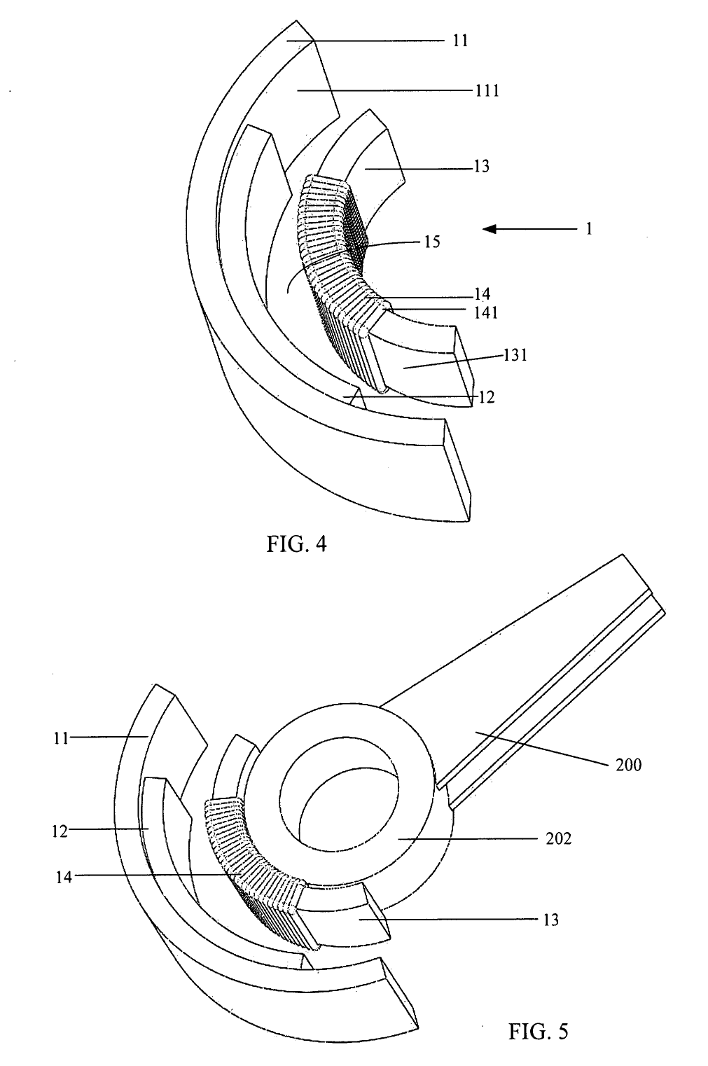

Referring to FIG. 4 in conjunction with FIG. 3, the VCM 1 of the disk drive includes an inner core 13 having an inner surface 131, an outer plate 11 having an inner surface 111, a permanent magnet 12, a coil of wire 141 wrapping around the inner core 13 to form a solenoid coil 14. The inner core 13 is configured to be perpendicular to the disk 101. The outer plate 11 is also configured to be perpendicular to the disk 101 and positioned in spaced relation to the inner core 13 such that a gap 15 is defined between the inner surfaces 131, 111 of the inner core 13 and the outer plate 11. The permanent magnet 12 is located in the gap 15 and attached to the inner surface 13 of the outer plate 11. The inner core 13, the outer plate 11, and the permanent magnet 12 are all arc-shaped and concentric with the pivot shaft 203.

FIG. 5 shows the VCM 1 assembled with the HSA 200. Referring to FIGS. 5-7, an outer surface of the coil 14 is bonded to the E-block 202 with heat conductive adhesive 204, and an inner surface of the coil 14 is bonded to the inner core 13 with heat conductive adhesive 16. With such structure, the stiffness of the coil 14 can be increased dramatically, which can reduce the coil torsion in the VCM 1. With the coil 14 directly attached to the E-block 202, the coil heat can be directly conducted to the pivot shaft via the E-block 202 and then the out surface of the hard disk drive, and the contact surface between the coil 14 and the E-block 202 increases a lot, so the heat conduction performance of the disk drive can also be improved.

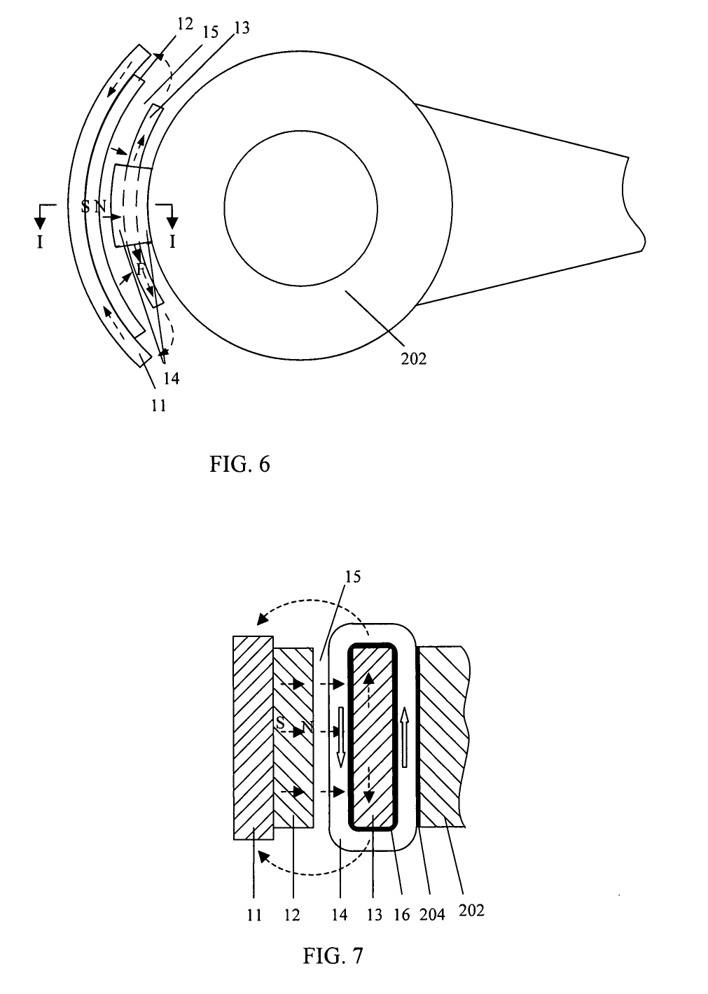

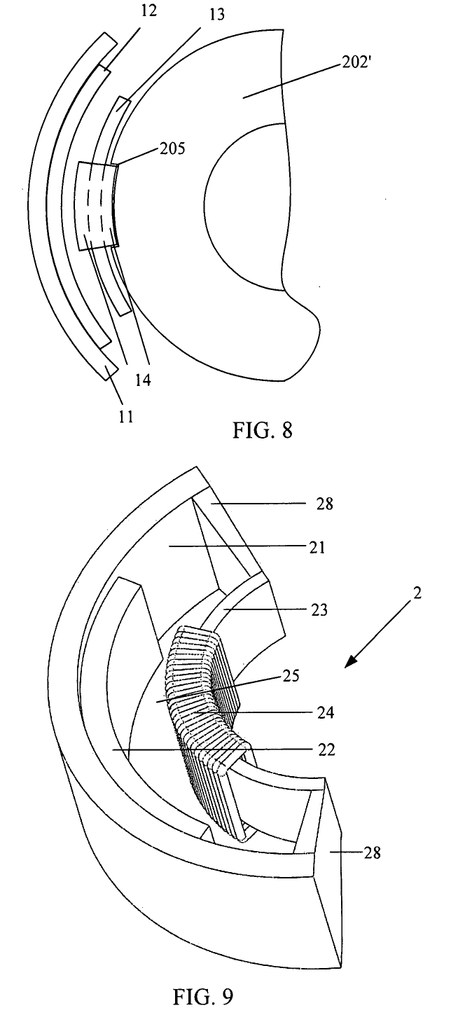

As shown in FIGS. 6 and 7, the coil 14 and the inner core 13 are bonded together so that the inner core 13 moves together with the coil 14 when the VCM is working and the stiffness of the coil 14 is further improved.

Referring to FIG. 3 and FIG. 6, when a predetermined current passes through the coil 14, a driving force F is generated on the coil 14 according to the Fleming's left-hand rule by the interaction between the current and a magnetic field formed by the magnet 12, the magnetic plate 11 and the inner core 13, thereby driving the HSA 200 rotation about the pivot shaft 203 and in turn cause the head 201 to move radially across the disk 101.

FIG. 8 shows another way assembling the VCM and the HSA in accordance with another embodiment of the present invention. The E-block 202′ defines a groove 205 in an outer surface thereof, and the coil 14 is partially pressed into the groove 205 so as to be fixed to the E-block 202′.

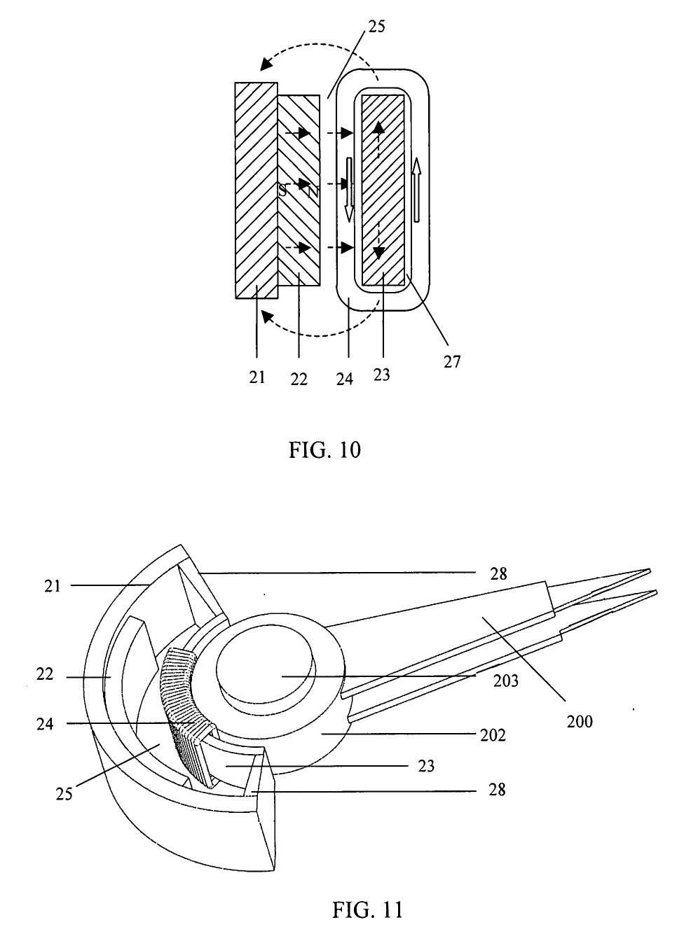

FIG. 9 is a perspective view of a VCM 2 according to another embodiment of the present invention. Referring to FIGS. 9-10, the structure of the VCM 2 is similar to that of the VCM 1, also comprising an inner core 23, an outer plate 21, a permanent magnet 22, and a solenoid coil 24. The differences are that the present VCM 2 has a pair of side plates 28 to close the gap 25 at opposite sides thereof and a clearance 27 exists between the coil 24 and the inner core 23. That is, the coil 24 and the inner core 23 are not bonded together. When the VCM 2 is excited, the coil 24 moves along the inner core 23.

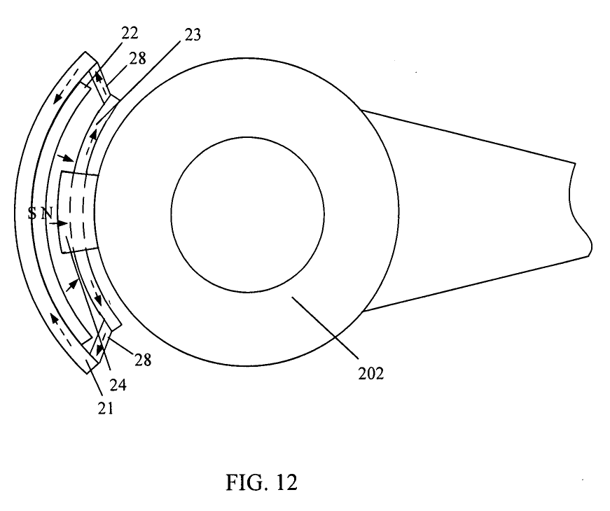

Generally speaking, magnetic flux lines are representative of the magnetic fields generated by a permanent magnet or by a current flowing in a wire. With respect to permanent magnets, magnetic flux lines are represented by dashed lines of force or flux that emerge from the magnet's north pole and enter the magnet's south pole, as shown in FIGS. 6, 7, 10 and 12. The density of the flux lines indicates the magnitude of the magnetic field generated by the magnet. If a magnetic conductive material, such as steel, is placed in a flux path, the magnetic flux will tend to pass through the steel rather than air surrounding the magnet, as the steel has a higher magnetic permeability. As best shown in FIG. 12, since the side plates 28, the inner core 23 and the outer plate 21 are made by magnetic permeable material such as steel, the structure of VCM 2 can prevent the leakage of magnetic flux, which will affect the magnetic disk 101.

FIG. 11 shows that the VCM 2 is attached to the E-block 202 of the HSA 200. The connection method is the same as that of the VCM 1 and the E-block 202 or 202′.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A voice coil motor for a hard disk drive comprising:
an inner core having an inner surface;
an outer plate having an inner surface, the outer plate being positioned in spaced relation to the inner core such that a gap is defined between the inner surfaces of the inner core and the outer plate;
a permanent magnet located in the gap and attached to the inner surface of the outer plate; and
a coil of wire wrapping around the inner core to form a solenoid coil.

2. The voice coil motor as claimed in claim 1, wherein the inner core, the outer plate, and the permanent magnet are all arc-shaped and concentric.

3. The voice coil motor as claimed in claim 1, wherein the coil and the inner core are bonded together so that the inner core moves together with the coil.

4. The voice coil motor as claimed in claim 1, wherein a clearance exists between the coil and the inner core to permit the coil to move along the inner core.

5. The voice coil motor as claimed in claim 4, further comprising a pair of side plates to close the gap at opposite sides thereof.

6. The voice coil motor as claimed in claim 4, wherein the outer plate is connected with the inner core at opposite sides thereof to close the gap.

7. A hard disk drive comprising:
a disk;
a spindle motor to spin the disk;
a head stack assembly having a head and an E-block at opposite ends thereof, the E-block being pivotally mounted on a pivot shaft; and
a voice coil motor to drive the head stack assembly rotation about the pivot shaft and in turn cause the head to move radially across the disk;
wherein the voice coil motor comprises:
an inner core having an inner surface, the inner core configured to be perpendicular to the disk;
an outer plate having an inner surface, the outer plate configured to be perpendicular to the disk and positioned in spaced relation to the inner core such that a gap is defined between the inner surfaces of the inner core and the outer plate;
a permanent magnet located in the gap and attached to the inner surface of the outer plate; and
a coil of wire wrapping around the inner core in a direction perpendicular to the disk to form a solenoid coil, the coil being bonded to the E-block.

8. The hard disk drive as claimed in claim 7, wherein the coil is bonded to the E-block with heat conductive adhesive.

9. The hard disk drive as claimed in claim 7, wherein the E-block defines a groove in an outer surface thereof, and the coil is partially pressed into the groove so as to be fixed to the E-block.

10. The hard disk drive as claimed in claim 7, wherein the inner core, the outer plate, and the permanent magnet are all arc-shaped and concentric with the pivot shaft.

11. The hard disk drive as claimed in claim 7, wherein the coil and the inner core are bonded together so that the inner core moves together with the coil.

12. The hard disk drive as claimed in claim 7, wherein a clearance exists between the coil and the inner core to permit the coil to move along the inner core.

13. The hard disk drive as claimed in claim 12, further comprising a pair of side plates to close the gap at opposite sides thereof.

14. The hard disk drive as claimed in claim 12, wherein the outer plate is connected with the inner core at opposite sides thereof to close the gap.
